(19) United States
(12) Patent Application Publication
(10) Pub. No.: US 2010/0133389 A1
(43) Pub. Date: Jun. 3, 2010

(54) Device for supporting a safety line

(75) Inventor: Pascal Lara, Nice (FR)

Correspondence Address: IPLM GROUP, P.A., POST OFFICE BOX 18455, MINNEAPOLIS, MN, 55418, US

(73) Assignee: CAPITAL SAFETY GROUP EMEA, CARROS (FR)

(21) Appl. No.: 11/919,128

(22) PCT Filed: May 23, 2006
(86) PCT No.: PCT/EP2006/062547

§ 371 Date: Oct. 24, 2007

(30) Foreign Application Priority Data
May 24, 2005 (FR) 0551359

(51) Int. Cl. A62B 35/00; F16L 3/08

(52) U.S. Cl. 248/65

(57) ABSTRACT

The invention concerns a device for supporting a safety line, in particular for preventing accidental fall of personnel working in sites involving such a risk, comprising at least one elongated tubular element (1) for guiding the passage of the cable (2) of said safety line, said tubular element (1) being maintained by at least two spaced apart supports (3) designed to be fixed to a stationary surface, characterized in that said elongated tubular element (1) is made of flexible plastic material, such that it can match the shape of a bend to be provided.

This invention relates to a device for supporting a safety line, also called a life-line.

The safety lines of this type are designed to prevent accidental falling of personnel working at considerable heights.

The personnel are attached to this line by means of a strap which guarantees their safety whilst enabling them to move.

Such safety lines are described, for example, in the documents U.S. Pat. No. 5,224,427, WO 02/092171 and WO 03/045504.

The devices of prior art for supporting these safety lines comprise elongated tubular elements each adapted to guide the passage of the safety line cable. Each tubular element is fixed to a wall or other fixed surface by means of a support.

To produce a curve, in order to negotiate the corner of a building, for is example, the cable is engaged in a steel bent tube whose curvature is adapted to the shape of the curve to be produced.

These bent steel tubes pose the following two problems, however.

Because of their rigidity, the bending of these tubes cannot be adapted locally to the curvature of the curve to be produced.

The friction of the cable in these bent tubes risks damaging it.

The object of this invention is to eliminate these drawbacks.

According to the invention the device for supporting a safety line, and in particular to prevent accidental falling of personnel working in places presenting this risk, comprising at least one elongated tubular element for guiding the passage of the cable of said safety line, this tubular element being retained by at least two supports spaced apart and designed to be fixed to a fixed surface, is characterised in that said elongated tubular element is of a flexible plastic material enabling it to conform to the shape of a curve to be produced.

This tubular element of a flexible plastic material therefore provides a simple, effective solution to the two problems described above in regard to the bent steel tubes.

The tubular element is preferably of polyamide, which is a flexible plastic material that is resistant and exhibits a low coefficient of friction with the steel cables.

Each of said supports preferably also retains the tubular element so that it has a freedom of rotation along its axis.

Therefore the tubular element does not risk being subjected to torsional stresses.

For this purpose each support preferably comprises, at one of its ends, a tubular cavity in which is engaged a section of the tubular element.

To block the tubular element axially relative to the supports, the section of the tubular element engaged in the tubular cavity of the support is limited at each end by an annular shoulder which forms a stop relative to the corresponding end of the tubular cavity of said support.

Other features and advantages of the invention will also be apparent from the following description.

In the attached drawings, given by way of non-exhaustive examples:

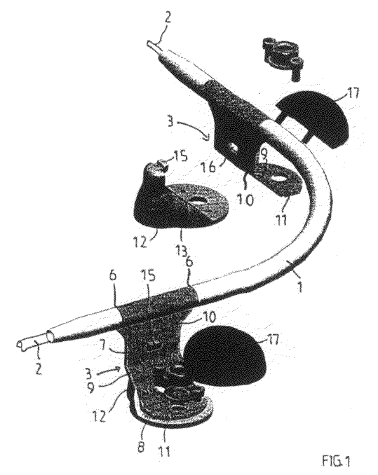

FIG. 1 is a perspective view of a device according to the invention for supporting a safety line,

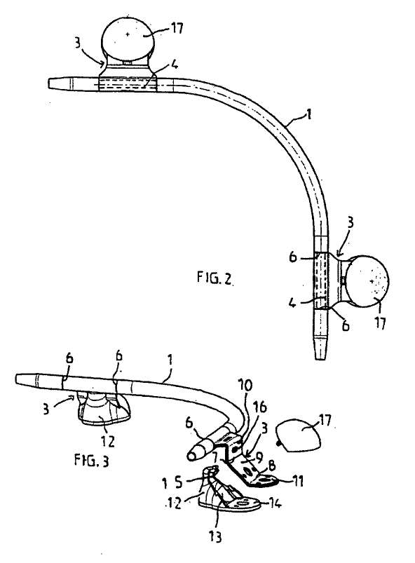

FIG. 2 is a plan view of the device shown in FIG. 1,

FIG. 3 is another perspective view of the device according to the invention,

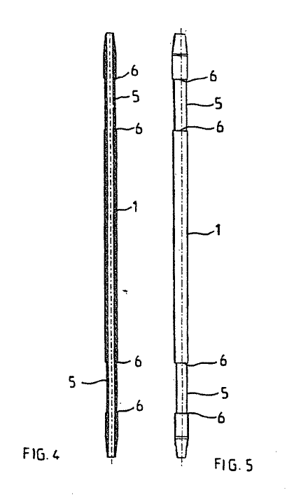

FIG. 4 is a view, in longitudinal section, of the tubular element of the device according to the invention, deprived of its fixing supports,

FIG. 5 is a plan view of the tubular element shown in FIG. 4.

As shown, particularly in FIG. 1, the device for supporting a safety line, in particular to prevent the accidental falling of personnel working in places presenting such a risk, comprises at least one elongated tubular element 1 for guiding the passage of cable 2 of the safety line.

This tubular element 1 is retained by two supports 3, spaced apart and designed to be fixed to a fixed surface, such as a wall of a building.

According to the invention, elongated tubular element 1 is of a flexible plastic material so that it is able to conform to the shape of a curve to be produced.

Tubular element 1 is preferably of polyamide, including charges of EPDM copolymer (ethylene—propylene—diene).

Each of the two supports 3 retains tubular element 1 so that it has a freedom of rotation along its axis.

For this purpose each support 3 comprises, at one of its ends (see FIG. 2), a tubular cavity 4 in which is engaged a shrunk-on section 5 (see FIGS. 4 and 5) of tubular element 1.

This shrunk-on section 5 of tubular element 1, engaged in tubular cavity 4 of support 3, is limited at each end by an annular shoulder 6, which forms a stop relative to the corresponding end of tubular cavity 4 of support 3.

Tubular element 1 is therefore blocked axially relative to supports 3, whilst being capable of rotating about its axis relative to the latter.

In the example shown (see FIGS. 1 and 3), each support 3 consists of a metal plate comprising two spaced bends 7, 8, perpendicular to the length of the metal plate to define an intermediate face 9, bounded by two end faces 10, 11 that are essentially perpendicular to each other.

Moreover, each support 3 comprises a base 12, designed to be supported on a fixed surface, a wall for example, and exhibiting an inclined surface 13 on which is supported intermediate face 9 of the metal plate.

This inclined surface 13 is connected to a surface 14 providing the support for end face 11 of the plate, which is opposed to tubular element 1.

Intermediate face 9 of the plate of support 3 may also be fixed directly to the fixed surface, i.e. without base 12.

It is also seen in FIGS. 1 and 3 that each base 12 comprises, in its upper section, a finger 15 that can be engaged in a hole 16 made in face 10 of the metal plate located close to tubular cavity 4.

When they are used, bases 12 increase the rigidity of the curve assembly under tension.

A more aesthetic appearance of the curve is thus produced.

To enable cable 2 of the safety line to make a curve, in order to negotiate the corner of a building, for example, the following procedure is adopted:
two holes, spaced part, are made on the wall of the building or on another fixed surface for fixing supports 3 of the device,
tubular element 1 is bent manually so that the latter assumes the shape of the curve to be produced,
supports 3 are fixed in relation to the two holes previously drilled in the wall or other fixed surface,
supports 3 are covered by a cap 17.

It is then sufficient to engage cable 2 in tubular element 1.

The main advantages of the device that has just been described are as follows:

Whatever the angle to be formed between two safety line sections, the flexibility of the tubular element allows any configuration.

Therefore, at the time of installation of the safety line, there is no constraining measurement or gauge for positioning fixing holes in the fixed surface.

In fact, the accuracy of the drilling in the concrete is not evident. The flexibility of the tubular element therefore allows certain inaccuracies.

The desired angle may be achieved as a function of the configuration of the building without a specific bending tool, whilst this is the case on the steel tube systems, for example.

It is also easy to alter the length of the tubular element in order to change the configuration to be produced.

If a worker falls there is better distribution of the cable tension through the different sections of the tubular element because of the low coefficient of friction.

This low coefficient of friction reduces the stresses on the receiving structure or, in any case, these stresses are better distributed throughout the curve.

Tests have shown that this distribution was 50 to 80% more favourable than in the case of the steel tubes.

Better retention of the cable is provided in the event of falling insofar as the steel on steel friction has until now risked damaging the cable, which is not the case with the plastic tubular element of the device according to the invention.

1. Device for supporting a safety line, in particular for preventing the accidental falling of personnel working in places presenting this risk, comprising at least one elongated tubular element (1) for guiding the passage of the cable (2) of said safety line, wherein this tubular element (1) is retained by at least two supports (3) spaced apart and designed to be fixed to a fixed surface, characterised in that said elongated tubular element (1) is of a flexible plastic material, so that it is able to conform to the shape of a curve to be produced.

2. Device according to claim 1, characterised in that the tubular element (1) is of polyamide.

3. Device according to claim 2, characterised in that the tubular element (1) is of polyamide including charges of EPDM copolymer (ethylene—propylene—diene).

4. Device according to claim 1, characterised in that each of said supports (3) retains the tubular element (1) so that it has a freedom of rotation along its axis.

5. Device according to claim 4, characterised in that each support (3) comprises, at one of its ends, a tubular cavity (4) in which is engaged a section (5) of the tubular element (1).

6. Device according to claim 5, characterised in that the section (5) of the tubular element (1), engaged in the tubular cavity (4) of the support, is limited to each end by an annular shoulder (6) which forms a stop relative to the corresponding end of the tubular cavity (4) of said support (3).

7. Device according to claim 1, characterised in that each support (3) consists of a metal plate comprising two bends (7, 8) spaced apart and perpendicular to the length of the metal plate in order to define an intermediate face (9) bounded by two end faces (10, 11) essentially perpendicular to each other.

8. Device according to claim 7, characterised in that each support (3) also comprises a base (12) designed to be supported on said fixed surface and exhibiting an inclined surface (13) on which is supported the intermediate face (9) of said metal plate, which is connected to a surface (14) providing a support for the end face (11) of said plate opposed to the tubular element (1).

9. Device according to claim 8, characterised in that the intermediate face (9) of the plate comprises means that enable it to be fixed directly on said fixed surface.

10. Device according to claim 8, characterised in that said base (12) comprises, in its upper section, a finger (15) that is able to engage in a hole (16) made in said metal plate close to said tubular cavity (4).

11. Device according to claim 2, characterised in that each of said supports (3) retains the tubular element (1) so that it has a freedom of rotation along its axis.

12. Device according to claim 3, characterised in that each of said supports (3) retains the tubular element (1) so that it has a freedom of rotation along its axis.

13. Device according to claim 2, characterised in that each support (3) consists of a metal plate comprising two bends (7, 8) spaced apart and perpendicular to the length of the metal plate in order to define an intermediate face (9) bounded by two end faces (10, 11) essentially perpendicular to each other.

14. Device according to claim 3, characterised in that each support (3) consists of a metal plate comprising two bends (7, 8) spaced apart and perpendicular to the length of the metal plate in order to define an intermediate face (9) bounded by two end faces (10, 11) essentially perpendicular to each other.

15. Device according to claim 4, characterised in that each support (3) consists of a metal plate comprising two bends (7, 8) spaced apart and perpendicular to the length of the metal plate in order to define an intermediate face (9) bounded by two end faces (10, 11) essentially perpendicular to each other.

16. Device according to claim 5, characterised in that each support (3) consists of a metal plate comprising two bends (7, 8) spaced apart and perpendicular to the length of the metal plate in order to define an intermediate face (9) bounded by two end faces (10, 11) essentially perpendicular to each other.

17. Device according to claim 6, characterised in that each support (3) consists of a metal plate comprising two bends (7, 8) spaced apart and perpendicular to the length of the metal plate in order to define an intermediate face (9) bounded by two end faces (10, 11) essentially perpendicular to each other.
